(19) United States
(12) Patent Application Publication
(10) Pub. No.: US 2013/0322101 A1
(43) Pub. Date: Dec. 5, 2013

(54) DEVICE FOR CONTROLLING HIGH AND LOW BEAM OF A HEADLIGHT

(71) Applicants: Chin-Yun HUANG, Tainan (TW); Hsian-Yi HUANG, Tainan (TW); Hsiu-Ming HUANG, Tainan (TW)

(72) Inventors: Chin-Yun HUANG, Tainan (TW); Hsian-Yi HUANG, Tainan (TW); Hsiu-Ming HUANG, Tainan (TW)

(21) Appl. No.: 13/487,261

(22) Filed: Jun. 4, 2012

(51) Int. Cl. B60Q 1/06

(52) U.S. Cl. 362/467

(57) ABSTRACT

A device for controlling high beam and low beam of a headlight includes a fixing plate formed with a recess and bored with two pin holes, two curved slots and a sliding slot. A valve base secured on the fixing plate is installed therein with an electromagnetic valve having a valve rod inserted in the interior and a spring fitted on the valve rod. A positioning seat is mounted on the valve rod and has one side provided with a connecting rod to be inserted through two mutually overlapped ends of two connecting plates and in the sliding slot of the fixing plate. Two boards are oppositely and pivotally assembled on the fixing plate, having their lower sides respectively and pivotally connected with the upper ends of the two connecting plates by insert pins, which are then inserted in the two curved slots of the fixing plate.

### BACKGROUND OF THE INVENTION

1. Field of the Invention

This invention relates to a device for controlling high and low beam of a headlight, particularly to one provided with an electro-magnetic valve for driving a valve rod to actuate two relatively disposed connecting plates to move upward and downward and push two corresponding boards to turn and shift inward or outward relatively for controlling a light projection range of the headlight.

2. Description of the Prior Art

An automobile headlight is generally provided with a high-low beam change-over device, which is to have the whole headlight turned for different angles for switching over lighting of high beam and low beam. However, the way of turning and changing the angles of the headlight to adjust high beam and low beam is likely to cause friction and damage to the power lines of the headlight and hence short service life of the headlight. Therefore, a device disposed with an electromagnetic valve to drive a board to move for controlling high beam and low beam of a headlight has been developed and employed. A conventional device 1 for controlling high-low beam of a headlight, as shown in FIGS. 1-4, is installed between a luminous member 100 of a lamp-stand 10 and a transparent shade 101, including a fixing plate 11 to be transversely assembled on the lamp-stand 10. The fixing plate 11 is cut with a notch 110 at a location corresponding with the luminous member 100 and disposed thereon with two opposite pivotal seats 111 and further bored with a plurality of combining holes 112. A valve base 12 to be fixed on one sidewall of the fixing plate 11 by a screw 102 has its interior installed with a electromagnetic valve 120 provided thereon with a valve rod 121 having an upper end disposed with a circular recess 122 for a spring 123 to be fitted therein. A board 13 is pivotally set at one side of the fixing plate 11 and located above the valve base 12, having two ends respectively formed with a pivotal piece 130 with an upper pivotal hole 131 and a lower pivotal hole 132. An elastic retaining member 14 closely rests against one side of the fixing plate 11 and has two ends respectively inserted in two corresponding lower pivotal holes 132 of the board 13. A pull plate 15 has two ends respectively inserted and engaged in two upper pivotal holes 131 of the board 13, bored with a fitting groove 150 to be engaged with the circular recess 122 of the valve rod 121 of the electromagnetic valve 120, with the pull plate 15 pressed on the spring 123. A welt 16 to be threadably mounted on another side of the fixing plate 11 is formed with plural insert holes 160 corresponding with the combining holes 112 of the fixing plate 11. Thus, when the valve rod 121 of the electromagnetic valve 120 is actuated to move upward and downward, the pull plate 15 will be directly pulled to actuate the board 13 to swing bias to alter the size of a light projection area for carrying out change-over of high beam and low beam of the headlight. Nevertheless, the conventional device for controlling high beam and low beam of a headlight is composed of too many components, taking too much time and labor in assembly and greatly increasing manufacturing cost.

Substantially, making use of an electromagnetic valve to drive a board to change its position for altering a light projection area become a design trend of controlling high beam and low beam of a headlight. Based on this concept, the inventor of this invention has devised an original device for controlling high beam and low beam of a headlight, which is able to improve the defects of the conventional device, simplify components, simplifying installation and lowering cost.

### SUMMARY OF THE INVENTION

This invention is devised to offer a device for controlling high and low beam of a headlight, simplifying components, convenient and quick in assembly, and able to greatly lower cost and elevate economical gain.

The device for controlling high and low beam of a headlight in the present invention includes a fixing plate, a valve base, two boards and two connecting plates.

The fixing plate has two ends respectively formed with a positioning strip with a positioning hole and an upper edge cut with a recess, further bored with two shaft holes, two corresponding curved slots and a sliding slot.

The valve base to be secured on one side of the fixing plate has an interior installed with an electromagnetic valve and its upper side disposed with a through hole communicating with the center of the electromagnetic valve. A valve rod is inserted in the through hole of the valve base and the center of the electromagnetic valve, and a positioning seat is mounted on the valve rod, having its underside provided with a stopping block and one side secured with a connecting rod to be inserted in the sliding slot of the fixing plate. A spring is fitted on the valve rod, having one end resisting the topside of the valve base and another end pushing against the underside of the positioning seat to enable the valve rod to be elastically moved upward or downward on the valve base.

The two boards provided relatively are pivotally assembled on one side of the fixing plate, having their lower sides respectively bored with a shaft hole and a pin hole. Two pivots are respectively inserted through the shaft holes of the two boards and in the two shaft holes of the fixing plate for pivotally setting the two boards on the fixing plate.

The two connecting plates to be positioned between the two boards and the valve base have their lower ends overlapping each other and respectively bored with an insert hole for the connecting rod at one side of the positioning seat on the valve base to be inserted therethrough. Further, the two connecting plates have their upper ends respectively formed with a pin hole, and two insert pins are respectively inserted through the pin holes of the two connecting plates and through the pin holes of the two boards and then in the two curved slots of the fixing plate.

Furthermore, the fixing plate is bored with a plurality of insert holes and positioning-engaging holes, and the valve base has one sidewall bored with threaded holes at locations corresponding with the insert holes of the fixing plate and provided with positioning projections at locations corresponding with the positioning-engaging holes of the fixing plate. Plural screws are respectively inserted through the insert holes of the fixing plate and screwed with the threaded holes of the valve base to secure the valve base at one side of the fixing plate.

Moreover, one of the two boards has one side edge protuberantly provided with a blocking piece positioned astride on the other board for covering the joint seam of the two boards.

### BRIEF DESCRIPTION OF DRAWINGS

This invention will be better understood by referring to the accompanying drawings, wherein:

FIG. 1 is an exploded perspective view of a conventional device for controlling high and low beam of a headlight;

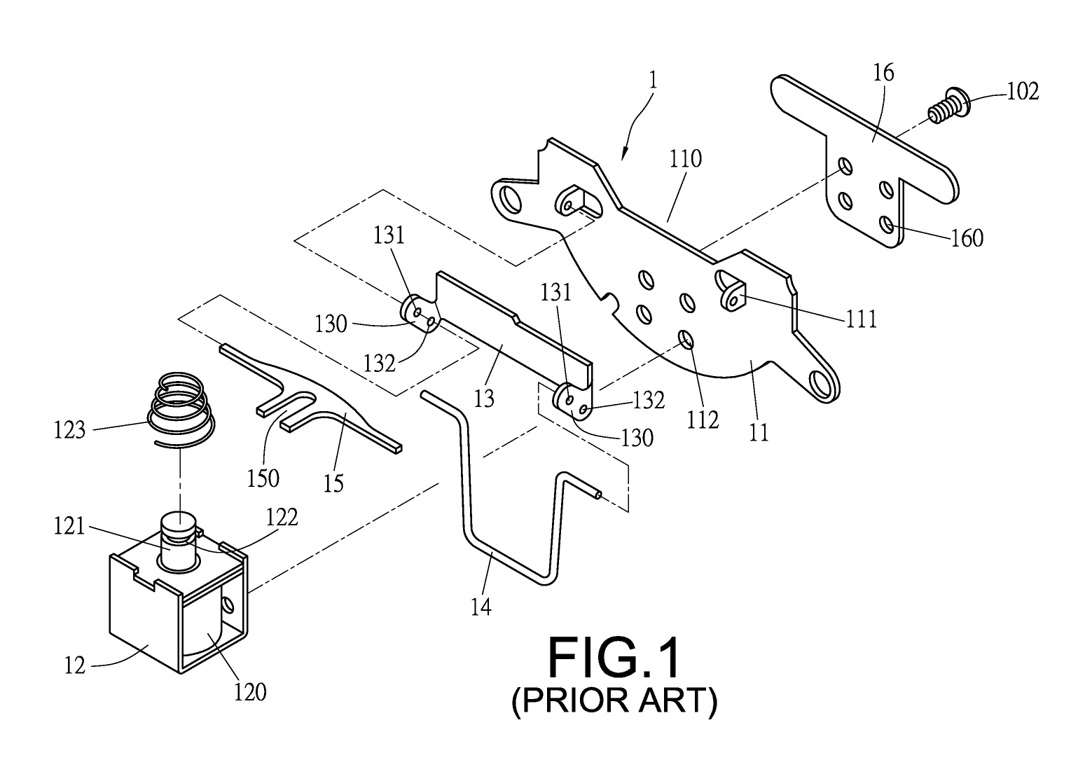

FIG. 2 is a perspective view of the conventional device for controlling high and low beam of a headlight;

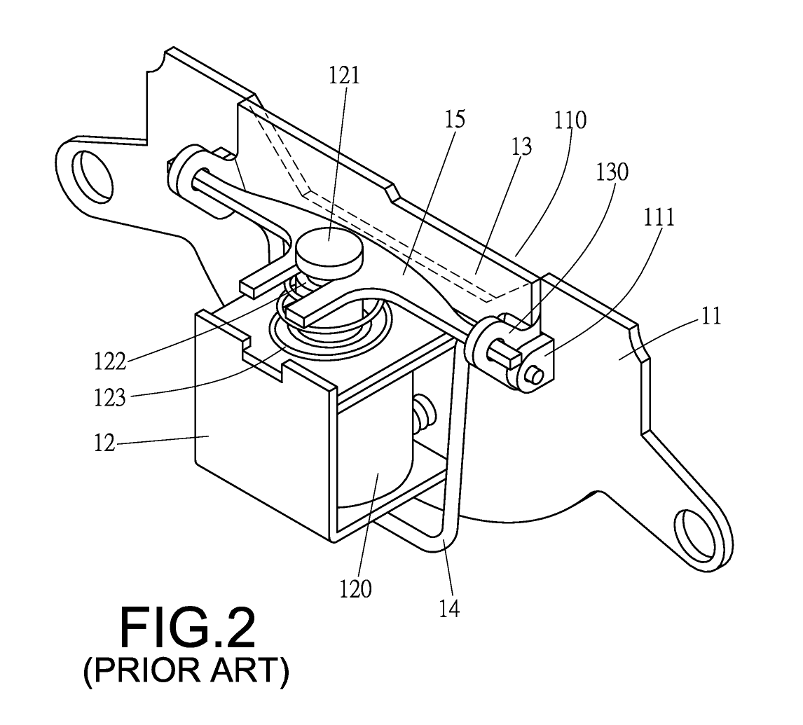

FIG. 3 is a side cross-sectional view of the conventional device for controlling high and low beam of a headlight, illustrating that the device carries out change-over to form low beam;

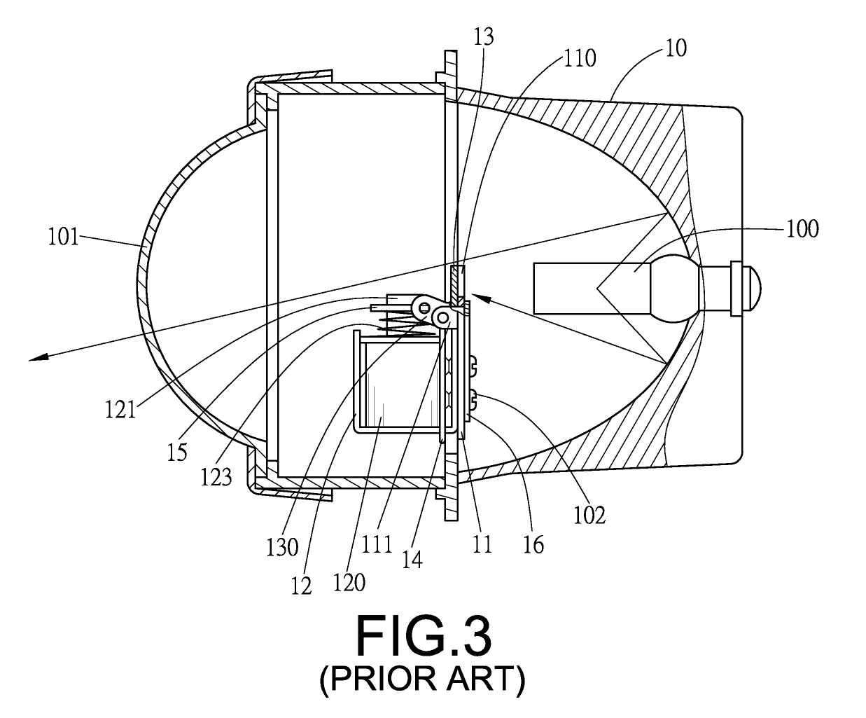

FIG. 4 is a side cross-sectional view of the conventional device for controlling high and low beam of a headlight, illustrating that the device carries out change-over to form high beam;

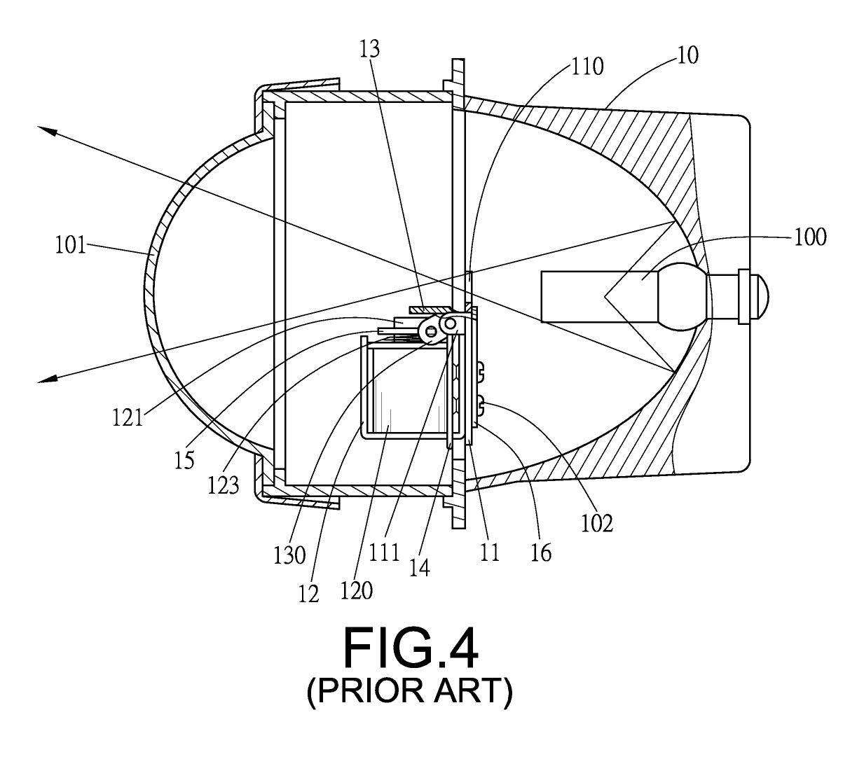

FIG. 5 is an exploded perspective view of a device for controlling high and low beam of a headlight in the present invention;

FIG. 6 is a perspective view of the device for controlling high and low beam of a headlight in the present invention;

FIG. 7 is a plane view of the device for controlling high and low beam of a headlight in the present invention, illustrating that the device is changed over to a low-beam condition;

FIG. 8 is a schematic view of the device assembled inside a lamp-stand and a transparent shade and changed over to a low-beam condition in the present invention;

FIG. 9 is a schematic view of the device for controlling high beam and low beam of a headlight in the present invention, illustrating that the device is changed over to a high-beam condition; and

FIG. 10 is a schematic view of the device assembled inside the lamp-stand and the transparent shade and changed over to a high-beam condition.

### DETAILED DESCRIPTION OF THE PREFERRED EMBODIMENT

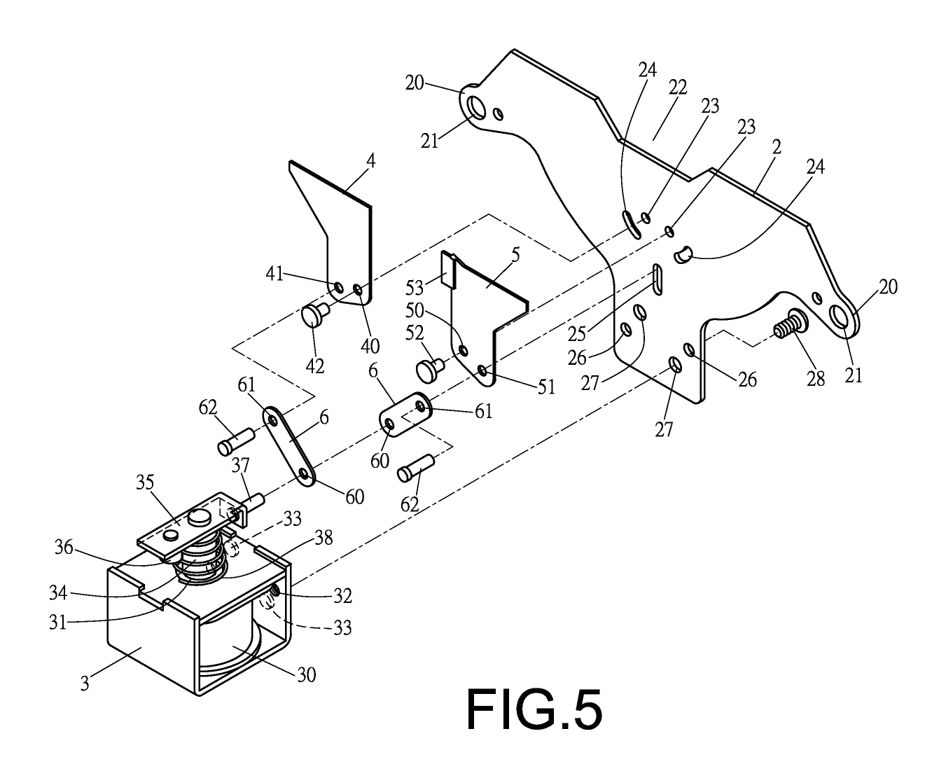

A preferred embodiment of a device for controlling high and low beam of a headlight in the present invention, as shown in FIG. 5, includes a fixing plate 2, a valve base 3, two boards 4, 5 and two connecting plates 6 as main components combined together.

The fixing plate 2 has two ends respectively formed with a positioning strip 20 with a positioning hole 21, an upper edge cut with a recess 22, an intermediate portion bored with two shaft holes 23, two opposite curved slots 24 and a sliding slot 25 and further a lower portion disposed with a plurality of insert holes 26 and positioning-engaging holes 27, with screws 28 respectively inserted in the insert holes 26.

The valve base 3 to be secured on one side of the fixing plate 2 is provided therein with an electromagnetic valve 30, and has its topside disposed with a through hole 31 communicating with the center of the electromagnetic valve 30 and one sidewall bored with threaded holes 32 at locations corresponding with the insert holes 26 of the fixing plate 2 and provided with positioning projections 33 at locations corresponding with the positioning-engaging holes 27 of the fixing plate 2. A valve rod 34 is inserted through the through hole 31 of the valve base 3 and in the center of the electromagnetic valve 30 and has its upper side mounted with a positioning seat 35 having an underside set with a stopping block 36 and one side secured thereon with a connecting rod 37 to be inserted in the sliding slot 25 of the fixing plate 2. A spring 38 is fitted on the valve rod 34, having one end resisting against the topside of the valve base 3 and another end resisting against the underside of the positioning seat 35 to enable the valve rod 34 to be elastically moved upward or downward on the valve base 3.

The two boards 4 and 5 to be pivotally assembled at one side of the fixing plate 2 respectively have a lower side bored with a shaft hole 40, 50 and a pin hole 41, 51, and two pivots 42, 52 are respectively inserted through the shaft holes 40, 50 of the two boards 4 and 5 and then respectively inserted in the two shaft holes 23 of the fixing plate 2 to pivotally assemble the two boards 4 and 5 on the fixing plate 2. Further, the board 5 has one side edge protuberantly provided with a blocking piece 53 laid astride on the board 4.

The two connecting plates 6 are positioned between the two boards 4, 5 and the valve base 3, having their lower ends overlapping each other and respectively having a lower end bored with an insert hole 60 for the connecting rod 37 at one side of the positioning seat 35 to be inserted therethrough and an upper end disposed with a pin hole 61. Two insert pins 62 are respectively inserted through the two pin holes 61 of the two connecting plates 6 and further through the two pin holes 41, 51 of the two boards 4, 5, and then finally inserted in the two curved slots 24 of the fixing plate 2.

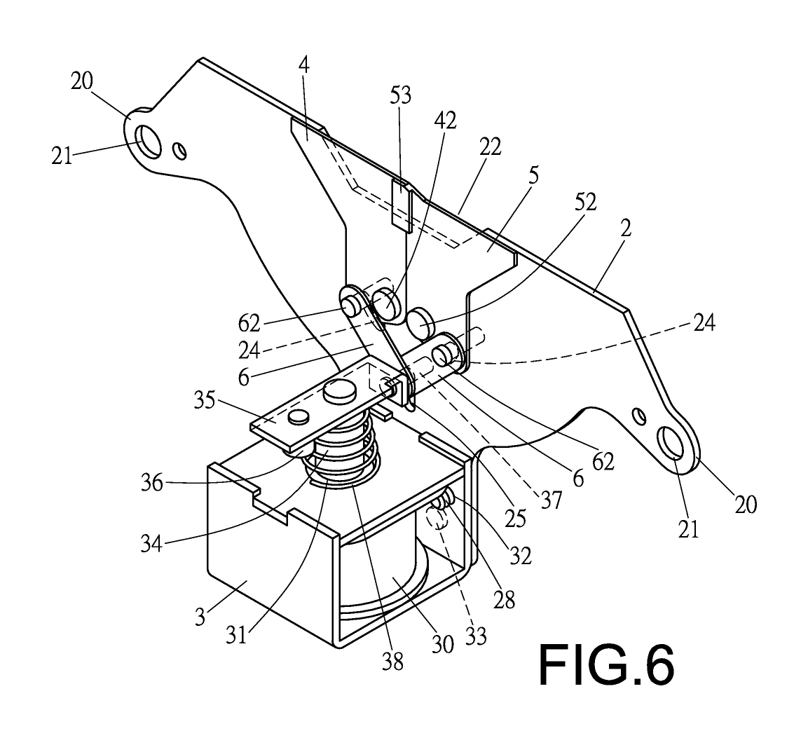

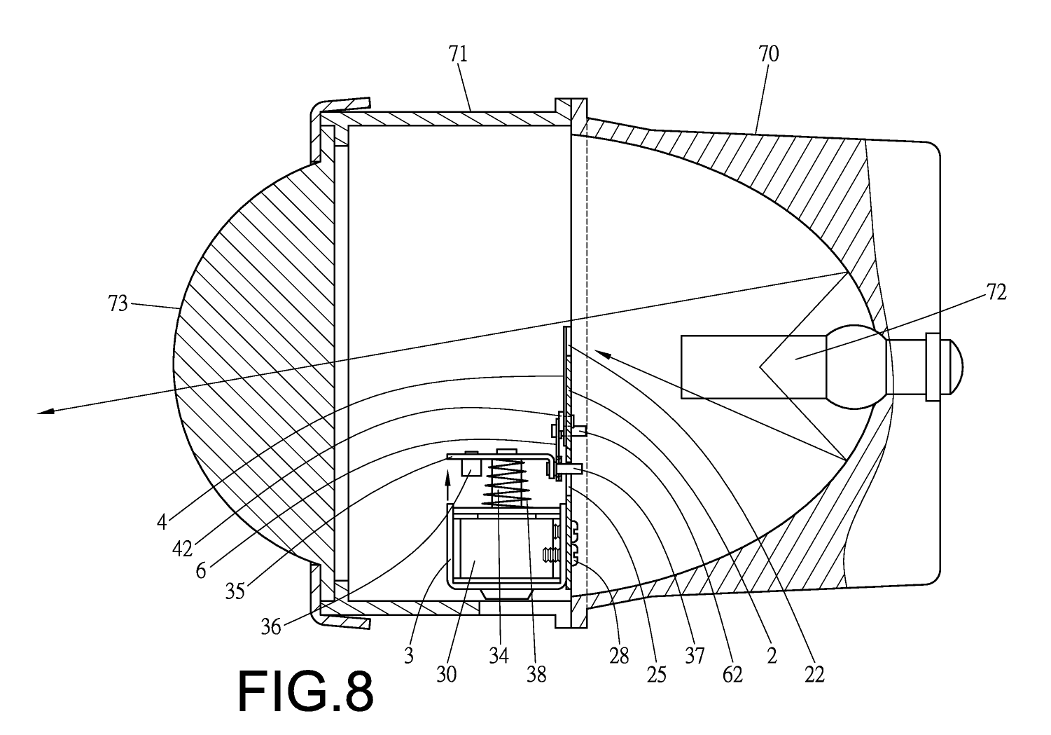

In assembling, referring to FIGS. 5-8, firstly, two adjacent edges of the two boards 4, 5 are closely positioned together, letting the blocking piece 53 of the board 5 positioned astride at one side of another board 4, and then the two boards 4, 5 is made to lean against one side of the fixing plate 2, letting the shaft holes 40, 50 of the two boards 4, 5 respectively aligned to the two shaft holes 23 of the fixing plate 2. Next, the two pivots 42, 52 are respectively inserted in the shaft holes 40, 50 of the two boards 4, 5 and the two shaft holes 23 of the fixing plate 2 to have the two boards 4, 5 pivotally mounted on one side of the fixing plate 2 and covered on the recess 22 at the upper edge of the fixing plate 2. Afterward, the upper ends of the two connecting plates 6 are respectively positioned close to the lower sides of the two boards 4, 5, making the pin holes 61 of the two connecting plates 6 aligned to the pin holes 41, 51 of the two boards 4, 5 and then, two insert pins 62 are respectively inserted through the pin holes 61 of the two connecting plates 6 and the pin holes 41, 51 of the two boards 4, 5 and further inserted in the two curved slots 24 of the fixing plate 2. Subsequently, the two connecting plates 6 have their lower ends overlapping each other, letting the two insert holes 60 first aligned to each other and then aligned to the sliding slot 25 of the fixing plate 2, and the valve base 3 has one side closely leaning against one side of the fixing plate 2 to have the positioning projections 33 at one side of the valve base 3 respectively engaged in the positioning-engaging holes 27 of the fixing plate 2. Then, two screws 28 are respectively inserted through the insert holes 26 of the fixing plate 2 and screwed in the threaded holes 32 of the valve base 3 to firmly set the valve base 3 on one side of the fixing plate 2, and the connecting rod 37 at one side of the positioning seat 35 over the valve base 3 is inserted through the two aligned insert holes 60 of the two connecting plates 6 and in the sliding slot 25 of the fixing plate 2. Lastly, the integral device for controlling high and low beam of a headlight is assembled between a lamp-stand 70 and a transparent shade seat 71, as shown in FIG. 8, thus finishing assembly of the device for controlling the high-low beam of a headlight.

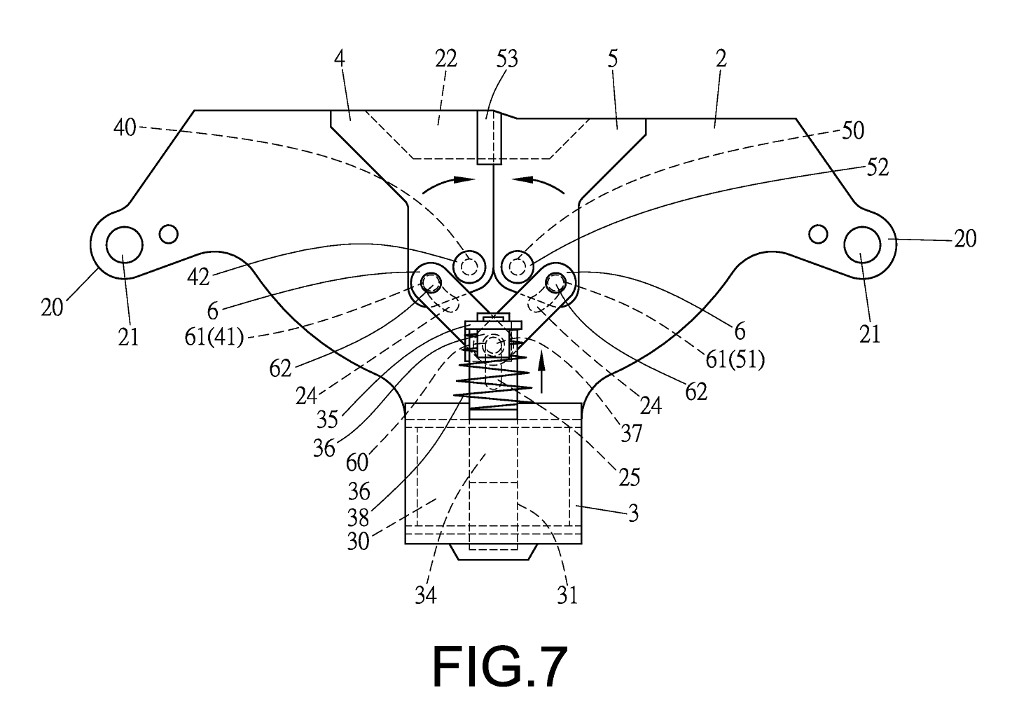

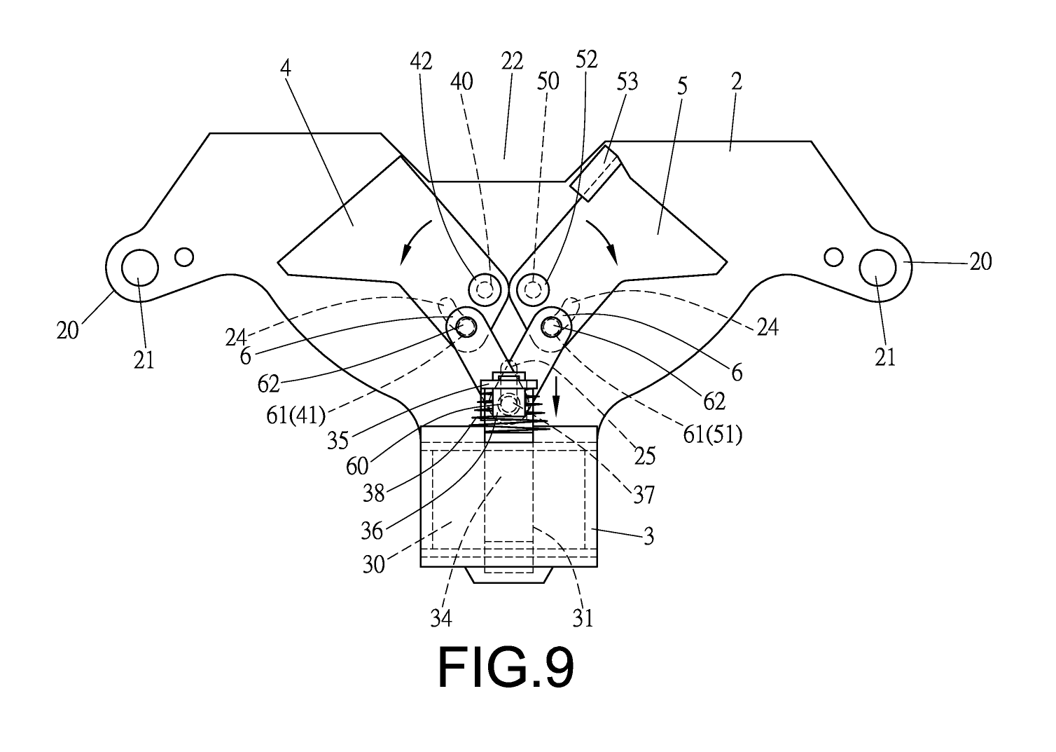

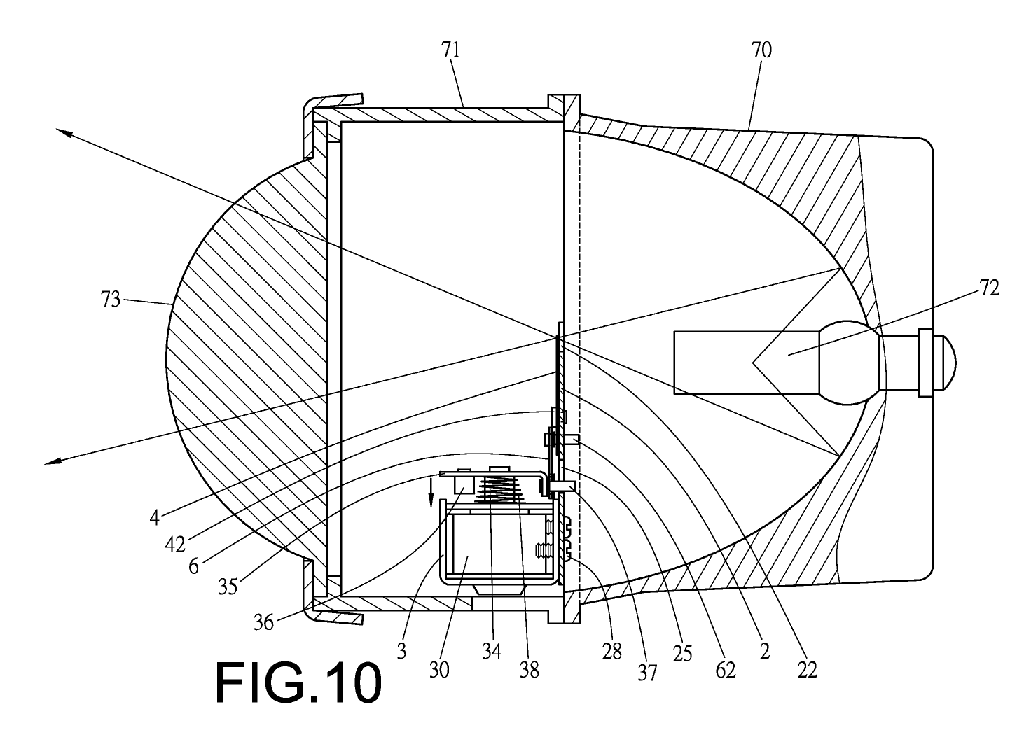

In using and operating, referring to FIGS. 7-10, when the electromagnetic valve 3 is electrically connected, the valve rod 34 will be attracted by the magnetic force of the electromagnetic valve 3 to move downward together with the positioning seat 35 and make the spring 38 in an elastically compressed state, as shown in FIG. 9. When the positioning seat 35 together with the connecting rod 37 at one side is shifted downward, the connecting rod 37 will actuate the two connecting plates 6 to move downward and will also slide and shift downward in the sliding slot 25 of the fixing plate 2. Meanwhile, with the two pivots 42, 52 of the two boards 4 and 5 acting as fulcrums, the two insert pins 62 at the upper ends of the two connecting plates 6 will slidably shift downward along the two curved through holes 24 of the fixing plate 2 and actuate the upper sides of the two boards 4 and 5 to turn and shift outward relatively. At this time, the two boards 4, 5 will no longer cover the notch 22 of the fixing plate 2, as shown in FIG. 10, so the refractive light emitted by the luminous member 72 inside the lamp stand 70 can completely be projected outward through the transparent shade 73 to form the light of high beam.

To have the lighting of high beam changed over to form lighting of low beam, simply make the electromagnetic valve 30 electrically disconnected to let the spring 38 recover its elastic force to push both the positioning seat 35 and the valve rod 34 to move upward, as shown in FIG. 7. Simultaneously, the connecting rod 37 at one side of the positioning seat 35 will drive the two connecting plates 6 to move upward, and the insert pins 62 at the upper ends of the two connecting plates 6 will push the two boards 4, 5 upward and in the mean time, with the pivots 42, 52 serving as fulcrums, the upper sides of the two boards 4, 5 will be actuated to turn and shift inward relatively and recover their original position, letting the corresponding edges of the two boards 4, 5 closely contact with each other anew to cover the recess 22 of the fixing plate 2, as shown in FIG. 8, thus forming a comparatively small light projection range for sending out light of low beam. In addition, after the two boards 4 and 5 are closed together, the blocking piece 53 provided at one side edge of the board 5 will function to fully cover the gap formed between the two boards 4 and 5 to stop refractive light from projecting out through the recess 22 of the fixing plate 2 and the joint seam of the two boards 4, 5.

Specifically, different from the conventional device in structure, the device for controlling high and low beam of a headlight of this invention can easily and conveniently be operated to carry out change-over of high beam and low beam of the headlight, simplifying components, enhancing efficiency of assembly and lowering manufacturing cost.

While the preferred embodiment of the invention has been described above, it will be recognized and understood that various modifications may be made therein and the appended claims are intended to cover such modifications that may fall within the spirit and scope of the invention.

What is claimed is:

1. A device for controlling high and low beam of a headlight comprising:
a fixing plate having two ends respectively formed with a positioning strip, said strip bored with a positioning hole, said fixing plate having an upper edge cut with a recess, said fixing plate provided with two shaft holes, two opposite curved slots and a sliding slot;
a valve base secured on one side of said fixing plate, said valve base disposed with an electromagnetic valve in an interior, said valve base having a topside bored with a through hole communicating with a center of said electromagnetic valve, a valve rod inserted in said through hole of said valve base and the center of said electromagnetic valve, a positioning seat mounted on said valve rod, said positioning seat having an underside fixed with a stopping block, said positioning seat having one side set with a connecting rod, said connecting rod inserted in said sliding slot of said fixing plate, a spring fitted on said valve rod, said spring having one end resisting an upper side of said valve base and another end pushing against an underside of said positioning seat, said spring enabling said valve rod to be elastically moved upward or downward on said valve base;
two boards pivotally assembled on one side of said fixing plate, said two boards disposed relatively, said two boards having their lower sides respectively bored with a shaft hole and a pin hole, said shaft holes of said two boards respectively having a pivot inserted therein, said pivots further respectively inserted in said two shaft holes of said fixing plate for pivotally assembling said two boards on said fixing plate; and
two connecting plates positioned between said two boards and said valve base, said two connecting plates having their lower ends overlapping each other, said two connecting plates having their lower ends respectively disposed with an insert hole for said connecting rod at one side of said positioning seat on said valve base to be inserted therethrough, said two connecting plates having their upper ends respectively bored with a pin hole for an insert pin inserted therein, said two insert pins further inserted in said pin holes of said two boards and in said two curved slots of said fixing plates.

2. The device for controlling high and low beam of a headlight as claimed in claim 1, wherein said fixing plate is provided with a plurality of insert holes and positioning-engaging holes, and said valve base has one sidewall bored with threaded holes at locations corresponding with said insert holes of said fixing plate, said valve base further disposed with positioning projections at locations corresponding with said positioning-engaging holes of said fixing plate, plural screws respectively inserted through said insert holes of said fixing plate and screwed in said threaded holes of said valve base to secure said valve base at one side of said fixing plate.

3. The device for controlling high and low beam of a headlight as claimed in claim 1, wherein one of said two boards has one side edge protuberantly provided with a blocking piece, and said blocking piece is laid astride on the other of said two boards.
